(19) United States
(12) Patent Application Publication
(10) Pub. No.: US 2005/0221468 A1
(43) Pub. Date: Oct. 6, 2005

(54) Method, process, apparatus, and product for remediation of hydrocarbon contamination

(76) Inventors: Douglas A. MacKrell, Whitehorse (CA); Paul A.N. Hutlet, Whitehorse (CA)

Correspondence Address: DARYL W SCHNURR;MILLER THOMSON LLP, PO BOX 578, SUITE 700, 22 FREDERICK STREET, KITCHENER, ON, N2G 4A2, CA

(21) Appl. No.: 10/995,290

(22) Filed: Nov. 24, 2004

(30) Foreign Application Priority Data
Apr. 1, 2004 (CA) 2,463,120

(51) Int. Cl. C12S 1/00

(52) U.S. Cl. 435/262.5

(57) ABSTRACT

A process and system for in situ remediation of contaminated soil includes the distribution of treated sewage effluent into the soil. The treated sewage effluent promotes the number and growth of naturally occurring microorganisms which initiates or accelerates the remediation of the contaminant.

Priority is claimed based upon Canadian Informal Application serial number 2,463,120 filed on Apr. 1, 2004.

### BACKGROUND OF THE INVENTION

1. Field of the Invention

The present invention relates to a process and system for environmental remediation using waste sewage. More particularly, the invention relates to a process and system for in situ remediation of contaminated soil using treated sewage effluent.

2. Description of the Prior Art

One traditional method of remediating contaminated soil, such as hydrocarbon contaminated soil, is referred to as the “dig and haul” method. In this method, the soil is usually excavated and transported to an off-site location, referred to as a remediation cell, where it is spread out in a large area to allow the contaminants to evaporate and/or to be broken down by bacteria or other microorganisms present in the soil. The soil may be turned every three months or so to further facilitate remediation.

In warmer or tropical climates, remediation to desirable levels using this method may be achieved in about a year. However, environmental and other conditions extend remediation time, and time periods of four to five years are common for cooler or freezing climates. In addition to the long time required for remediation, the “dig and haul” method can be very expensive due, in part, to the excavation and transportation costs as well as costs associated with the remediation at the remediation facility.

In situ remediation methods have been developed, but these methods can be expensive, and slow, particularly in cooler or freezing climates. In some climates, such as in Yukon, Canada or Alaska, USA, having extended periods of cold weather or freezing in the winter months, present in situ methods, if they work at all, can be as expensive as “dig and haul” methods due to the lengthy remediation process and the set-up and tear-down costs.

In situ methods of remediating contaminated soils have been developed that involve mixing the contaminated soil with a depolluting agent.

U.S. Pat. No. 5,656,486 to Daniels discloses a process for treating and conditioning poultry manure by composting with the addition of microorganisms having an affinity for hydrocarbons to remediate soil contaminated with hydrocarbons. The compost is distributed onto contaminated soil and tilled and irrigated if desired. Over time, the hydrocarbons are biologically degraded. This “compost” type method may require considerable time to allow the manure to compost and requires the addition of microorganisms. In addition, this method may be less effective for remediation of contaminated soil at depth as the compost is only applied at or near the soil surface.

U.S. Pat. No. 5,885,203 to Pelletier discloses an in situ method of remediating contaminated soil involving the distribution of depolluting agents, such as microorganisms, by an irrigation/drainage system flowing into and out of the contaminated soil. A disadvantage of this type of system is that it relies on a drainage system as well as the requirement that the drained fluid must be disposed of or otherwise dealt with. In addition, it requires the addition of microorganisms.

There is therefore a need for a process and system for soil remediation that provides greater flexibility with respect to the depth of remediation. Further, there is a need for a process and system for soil remediation that uses an abundant waste product that may be left in the soil during and after completion of remediation to an acceptable level, thus avoiding removal and disposal effort and the associated costs. The present invention is directed to these needs.

### SUMMARY OF THE INVENTION

In general terms, the present invention provides a process and system for remediation of contaminated soil by the distribution of treated sewage effluent into the contaminated soil. Microorganisms naturally occurring in the soil can break down contaminants, for example, hydrocarbons, BTEX compounds or pentachlorophenol (also pentachlorophenal or PCP) in the soil through aerobic biological processes, and these processes can be initiated, accelerated, or supported by the addition of nutrients. Sewage is a source of suitable nutrients, such as nitrogen, phosphorus, oxygen, and moisture. The present invention allows for nutrients in the form of nitrogen, phosphorus, oxygen, and moisture to be delivered into the contaminated soil, thus allowing the microorganisms in the soil to break down the contaminant and provide environmental remediation by reducing the level of contamination. Where the soil conditions are not normally warm enough to support biological remediation at a sufficient rate, the present invention also allows for the addition of heat to the soil to help provide a suitable warm environment for the microorganisms, thus initiating or accelerating remediation.

The treated sewage effluent is distributed into the contaminated soil, for example, by irrigation, to contact the said effluent with the contaminated soil wherein the treated sewage effluent provides nitrogen, phosphorus, oxygen, and moisture to microorganisms pre-existing in the soil to promote bioremediation so that the microorganisms break down the contaminants. Because the treated sewage effluent is typically warm and typically contains further microorganisms, it may also add heat, microorganisms, or both, to the soil to further initiate or facilitate remediation.

In the present invention, nitrogen, phosphorus, oxygen, heat and moisture are introduced by the treated sewage effluent, all combined with naturally occurring micro-organisms to enable, promote, or accelerate the bioremediation of contaminants such as hydrocarbons or BTEX compounds.

While the present invention is directed at in situ remediation of contaminated soil, it is also useful to promote and expedite remediation of soil in an ex situ or even “dig and haul” situation, for example at a remediation cell or other location with a source of treated sewage effluent readily available.

The present invention also lowers waste treatment infrastructure and operating costs and avoids disposal of treated sewage effluent into rivers and lakes, and instead the present invention “recycles and re-uses” the treated sewage effluent for remediation of contaminated soil.

A field distribution system and a field warming system supply warm treated sewage effluent and warm air respectively into the soil, thus enabling the process and system to be used twelve months of the year, even in very cold or freezing climates, thus initiating or accelerating the remediation process.

Accordingly, in one aspect, the present invention is a process for in situ remediation of contaminated soil, said soil being contaminated with at least one contaminant selected from the group of hydrocarbons, BTEX compounds, polyaromatic hydrocarbons and pentachlorophenol, said process comprising:
(a) choosing a treated sewage effluent, said effluent having a maximum biochemical oxygen demand five day test and total suspended solids in water of substantially 10 to 160 milligrams per litre; and
(b) distributing said effluent into said soil and waiting a period of time to allow said effluent to cause said contaminant to be at least partially remediated.

Preferably, the treated sewage effluent has a total suspended solids in water of substantially 140 to 160 milligrams per litre, substantially 45 to 140 milligrams per litre, substantially 30 to 45 milligrams per litre, substantially 10 to 30 milligrams per litre, or substantially 10 milligrams per litre. Preferably, the treated sewage effluent is primary effluent quality, secondary effluent quality, or tertiary effluent quality.

Preferably, the process is carried out in repeating cycles. Preferably, warm air is blown into the soil after the effluent has been distributed into the soil. More preferably, the steps of effluent distribution followed by warm air distribution are carried out in cycles. Preferably, a distribution system is formed within the soil with substantially horizontal flow permeable conduits, vertical flow permeable conduits, inclined flow permeable conduits or a combination thereof.

Preferably, the treated sewage effluent is maintained at a temperature at between about 15° C. to about 37° C. More preferably, the treated sewage effluent is maintained at a temperature at between about 25° C. to about 35° C. Preferably, the treated sewage effluent is oxygenated. Preferably, the treated sewage effluent is derived by treating sewage with a treatment process. More preferably, the treatment process comprises a fixed activated sludge treatment system.

Preferably, the sewage is residential sewage, commercial wastewater, wastewater, blackwater, blackwater/greywater, agricultural wastewater, or a mix thereof. Optionally, the treated sewage effluent receives ultraviolet radiation before said effluent is distributed into the soil. Ultraviolet radiation is preferably used when the treated effluent may come into contact with any form of water such as groundwater, high water tables or fresh water resources.

Preferably, the contaminated soil is at a temperature of at least 5° C. More preferably, the soil temperature is at least 10° C.

In another aspect, the present invention is a system for remediation of contaminated soil, said soil being contaminated with at least one contaminant selected from the group of hydrocarbons, BTEX compounds, polyaromatic hydrocarbon and pentachlorophenol, said process comprising a treated sewage effluent having a maximum biochemical oxygen demand five day test and total suspended solids of substantially 10 to 160 milligrams per litre of water, means for contacting said contaminant with said effluent to at least partially remediate said contaminant after a period of time.

Preferably, the treated sewage effluent is of primary, secondary or tertiary effluent quality. Preferably, a distribution network provides means for contacting said contaminant with said effluent. The distribution network may consist of substantially horizontal or vertical or inclined passages, or a mix thereof. Preferably, the distribution network is a grid system consisting of connected substantially horizontal flow permeable conduits and substantially vertical passages. Preferably, the distribution network is formed of flow permeable conduits.

Preferably, the system further comprises sewage treatment means for treating sewage to prepare the treated sewage effluent. More preferably, the sewage treatment means comprises a fixed activated sludge treatment system.

### BRIEF DESCRIPTION OF THE DRAWINGS

Embodiments of the invention will now be described with reference to the accompanying drawings, in which:

FIG. 1 is a schematic process flow diagram of an embodiment of the system of the present invention;

FIG. 2 is a schematic diagram of a field distribution system of an embodiment of the present invention, depicting distribution of treated sewage effluent into contaminated soil;

FIG. 3 is a schematic diagram of a field distribution system of an embodiment of the present invention, depicting distribution of warm air into the contaminated soil through the field distribution system;

FIG. 4 is a schematic diagram of a field distribution system of an embodiment of the present invention, depicting a warm air barrier created by the distribution of warm air into the contaminated soil as shown in FIG. 3;

FIG. 5 is a graph of test results obtained for a remediation process of the present invention applied in situ to soil contaminated with diesel fuel; and

FIG. 6 is a graph of test results obtained for a remediation process of the present invention applied in situ to soil contaminated with diesel fuel.

### DESCRIPTION OF A PREFERRED EMBODIMENT

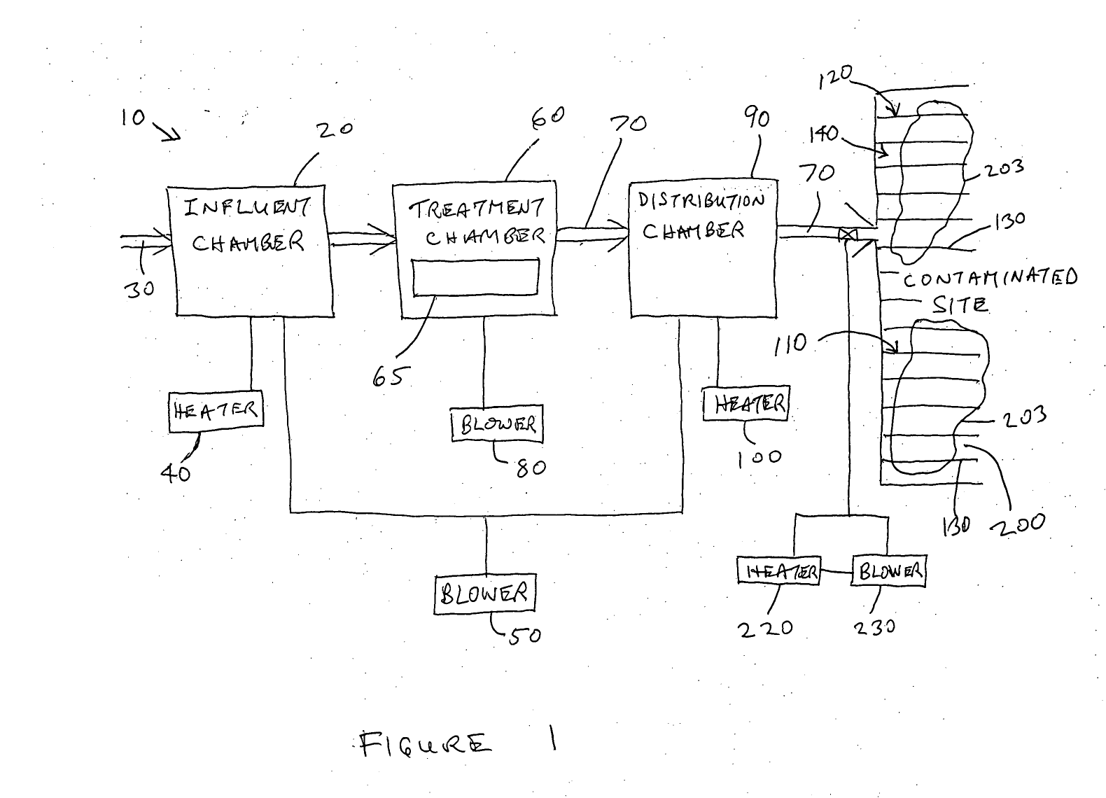

Referring generally to FIG. 1, the preferred embodiment of the present invention will be described. An apparatus 10 of the invention includes an influent chamber 20 for receiving sewage 30, a treatment chamber 60 for treating the sewage 30 to form treated sewage effluent 70, and a distribution chamber 90 for storage of the treated sewage effluent 70 before distribution to contaminated soil 200 contaminated with at least one contaminant 203. Raw Sewage enters the influent chamber 20. Solids settle out and the sewage is heated and oxygenated.

The present invention is effective for remediation of the contaminated soil 200, contaminated with at least one contaminant 203 that can be broken down through aerobic biological process. Examples of such a contaminant 203 include, but are not limited to, hydrocarbons, petroleum hydrocarbons (such as light and heavy extractable petroleum hydrocarbons), volatile petroleum hydrocarbons, BTEX (benzene, toluene, ethylbenzene, xylene) compounds, PAH (polyaromatic hydrocarbon) compounds, and pentachlorophenol.

The treated sewage effluent 70 may be used for remediation of different contaminated mediums, such as soil or groundwater or both. In the case of groundwater, at least a portion of the contaminant may be present at or near the upper level of the groundwater or may be at least partially emulsified in the groundwater. Remediation of groundwater may be initiated or promoted indirectly by remediation of the contaminated soil 200 proximate to the groundwater contamination (e.g. at the water table) or remediation may be initiated or promoted directly on the groundwater by breaking down the at least one liquid contaminant 203 at or near the interface of the groundwater and the said contaminant 203 or at or near the interface of the said contaminant 203 and the contaminated soil 200.

As used herein, the sewage 30 means at least one of Sewage, Septage, Residential Sewage, Commercial Wastewater, High Strength Sewage, Blackwater, Blackwater/Greywater combination, Agricultural Wastewater or a mixture thereof.

“Sewage” means human excreta or water-carried wastes from drinking, bathing, laundering, and food processing or preparation, and may also be known as domestic wastewater.

“Septage” means the liquids, solids, fats, oils, and greases pumped out of domestic sewage septic tanks.

“Residential Sewage” or “Domestic Sewage” means that the sewage has a Biochemical Oxygen Demand (BOD), 5 day test, and a total suspended solids (TSS) of not greater than 250 mg/l each (some jurisdictions use 350 mg/l).

“Commercial Wastewater” or “Industrial Wastewater” or “High Strength Sewage” is process wastewater from establishments such as, but not limited to, stand-alone coffee shops that process coffee beans or pulp and paper mill operations. “High Strength Sewage” or “High Strength Wastewater” or “Commercial Wastewater” means sewage that has a BOD, 5 day test, and a total suspended solids of greater than 250 mg/l each (some jurisdictions use 350 mg/l) and may contain fats, oils and grease concentrations greater than 35 mg/l. Typical sources would include pubs or restaurants.

“Blackwater” means only human excreta in toilet water.

“Greywater” means only water-carried wastes from drinking, bathing, laundering, and food processing or preparation.

“Agricultural Wastewater” means the excreta from farmed animals and the water carried wastes from animal or barn wash down or in the case of dairy farms means an additional water carried waste from milking operations.

The sewage 30 may be continuously or intermittently oxygenated or heated, or both, in the influent chamber 20. Preferably, a heater 40 is used to heat the sewage 30 in the influent chamber 20. Preferably, an air blower 50 is used to supply air to oxygenate the sewage 30 in the influent chamber 20. In the preferred embodiment, the temperature of the sewage 30 in the influent chamber 20 is maintained between substantially 25° C. and substantially 35° C.

Preferably, the sewage 30 is retained in the influent chamber 20 for an appropriate retention time before being transported from the influent chamber 20, but the retention is not essential. The retention time will be determined by the quality, quantity, and classification of raw sewage being utilized. For example, commercial waste may have a longer retention time than residential waste. In the preferred embodiment, any heavy or free solids in the sewage 30 at least partially settle out in the influent chamber 20 and do not transfer to the treatment chamber 60, and may be removed from the influent chamber 20 periodically for disposal. The sewage is preferably heated to a maximum temperature of approximately 37° C.

The size of the influent chamber 20 its volume capacity and the design of the air blower 50) are dependent on the size of each contaminated site.

In the preferred embodiment, the sewage 30 is transported from the influent chamber 20 to the treatment chamber 60 by sewage transport means in the form of a pump (not shown). However, the sewage transport means may be a gravity feed, a pressure differential, or other system to move the sewage 30 from the influent chamber 20 to the treatment chamber 60.

Preferably, the treatment chamber 60 applies a treatment process in the form of a treatment device 65 to treat the sewage 30 to a primary, secondary, or tertiary effluent quality to form treated sewage effluent 70. Preferably, the sewage is oxygenated by an air blower 80. However, the treatment process may be any system, process or device that achieves the desired level of treatment. Preferably, the treatment process is adapted to provide a total nitrogen reduction of 70%. Preferably, the nitrate level in the treated sewage effluent 70 is less than 5 mg/litre.

“Primary Effluent Quality” means effluent that has a maximum biochemical oxygen demand 5 day test and a total suspended solids of about 140-160 mg/l each, for example, effluent from a Primary Treatment process, such as a septic tank.

“Secondary Effluent Quality” means effluent that has a biochemical oxygen demand 5 day test and a total suspended solids between about 30-45 mg/l each, for example, effluent from a Secondary Treatment process, such as an aerobic treatment unit (e.g. a.k.a. sewage treatment plant).

“Tertiary Effluent Quality” means effluent that has a biochemical oxygen demand 5 day test and a total suspended solids of 10 mg/l each and has reduced at least one other of fecal coliform, total nitrogen or phosphorus, for example, effluent from a Tertiary Treatment process, such as an aerobic treatment unit (a.k.a. sewage treatment plant).

Preferably, the treatment device 65 is adapted to treat the sewage 30 to at least a secondary effluent quality. More preferably, the treatment device 65 is a Fixed Activated Sludge Treatment™ (FAST™) system by Bio-Microbics Inc. adapted to treat the sewage 30 to at least a tertiary effluent quality to form treated sewage effluent 70. Preferably, the FAST system is adapted to treat the sewage 30 form treated sewage effluent 70, meeting National Sanitation Foundation (NSF) Standard 40, Class 1, Tertiary Effluent Quality with less than 10 Biochemical Oxygen Demand (BOD) and 10 Total Suspended Solids (TSS).

An air blower 80 may supply air to the treatment chamber 60 to oxygenate the sewage 30 or the treated sewage effluent 70 or both.

The influent chamber 30 and the treatment chamber 60 may be combined into a single, common chamber (i.e. the same chamber may be used for collecting influent and for treating sewage to form the treated sewage effluent 70). Preferably, the influent chamber 30 and the treatment chamber 60 are separate chambers.

The treated sewage effluent 70 may be directly distributed into the contaminated soil by gravity feed, pumping, pressure differential, or otherwise, for example, by an irrigation-type system (not shown). The treated sewage effluent 70 may be distributed into many differing conditions of contaminated soil 200. The method of distribution of the treated sewage effluent 70 will be adapted to accommodate the site-specific soil conditions. The soil type and composition will affect the rate at which bioremediation occurs. In soils having very low permeability, such as clays, remediation will not occur as rapidly as in a more permeable soil. If the permeability is high, then residual hydrocarbons are generally less and thus such soil would not require as much treatment. There are a multiplicity of species of microorganisms in the soil which are capable of degrading contaminants through aerobic biological processes. By providing the treated sewage effluent 70 to the contaminated soil 200, nutrients such as nitrogen, phosphorous, oxygen, and moisture create an environment which promotes the growth of the microorganisms. Microorganisms flourish and multiply in an environment providing carbon, nitrogen, phosphorous, moisture, and warmth and will consume a “food source” that provides these. For example, the presence of a hydrocarbon contaminant in the soil will cause those microorganisms in the soil that consume carbon to increase. But the increase will only result the slow remediation of the contaminant. The presence of the sewage effluent greatly increases the microorganisms that consume carbon, thereby accelerating the rate of remediation. In the present invention, the microorganisms will utilize at least a portion of the contaminant 203 as their carbon source, for example, a hydrocarbon contaminant or a BTEX contaminant. The microorganisms may use other carbon sources such as organic matter in the treated sewage effluent 70 first, but once that source is depleted they will then use the carbon contaminant, for example, hydrocarbon or BTEX contaminants. While not all microorganisms break down hydrocarbons, with the application of the treated sewage effluent 70 at a hydrocarbon contaminated site, a group of microorganisms known in the art as “hydrocarbon degraders” will have an advantage and flourish and eventually form the dominant population of microorganisms.

Microorganisms exist in the contaminated soil 200 where the present invention would be used and the treated sewage effluent 70 may also naturally contain suitable microorganisms. There is no evidence to suggest that there is a maximum depth at which microorganisms may be found. If a contaminant 203 can migrate through the contaminated soil 200, then so can the treated sewage effluent 70. Furthermore, when distributing the treated sewage effluent 70 into the soil, the treated sewage effluent 70 may also add further suitable microorganisms which will be carried to the same depth to which the contaminant 203 has migrated.

By providing nitrogen, phosphorus, oxygen, moisture and heat in a carbon rich environment, the present invention provides an environment where microorganisms will adapt to using the contaminant 203, for example a hydrocarbon or a BTEX compound as their carbon source which is the basic principle of bioremediation. The present treatment may not promote the growth of all microorganisms, but it will help select and promote the hydrocarbon degraders at a hydrocarbon contaminated site. Microorganisms will adapt to the available carbon source over time. Therefore, either the naturally occurring “aerobic” microorganisms will adapt, or the “aerobic” microorganisms that are present in the treated sewage effluent, will adapt, or both. At a typical site of contaminated soil 200, there may be ample carbon, but there may not be sufficient nitrogen or phosphorus. The present invention allows the provision of the missing nitrogen and phosphorus so that the microorganisms can multiply, adapt, and degrade the contaminant 203 at a much faster rate to at least reduce the level of contamination.

In the preferred embodiment, the treated sewage effluent 70 is stored in a distribution chamber 90 prior to being applied to the contaminated soil 200. In the preferred embodiment, the treated sewage effluent 70 is transported to the distribution chamber 90 by treated sewage effluent transport means in the form of a pump (not shown). However, the treated sewage effluent transport means may be a gravity feed, a pressure differential, or other system to move the treated sewage effluent 70 from the treatment chamber 60 to the distribution chamber 90.

The distribution chamber 90 may be any suitable material, such as fiberglass, epoxy-coated steel, concrete or plastic, with a volume dependent on the size of contaminated site.

Research has found that the naturally occurring microorganisms in cold climates, such as in Yukon, Canada, are effective at bioremediation down to temperatures of about 5° C. Thus, the treated sewage effluent 70 may be applied at a temperature as low as approximately 5° C. in such climates. In milder climates, a low of about 10° C. is more suitable. In the preferred embodiment, a heater 100 may be used to heat the treated sewage effluent 70 in the distribution chamber 90. Preferably, the treated sewage effluent 70 is maintained at a temperature of between about 15° C. and 37° C. in the distribution chamber 90. More preferably, the treated sewage effluent 70 is maintained at a temperature of between 25° C. and 35° C.

In the preferred embodiment, the air blower 50 provides air to the treated sewage effluent 70 in the distribution chamber 90. However, air can be supplied from any suitable source, and may be supplied in a continuous or intermittent manner.

The treatment chamber 60 may be manufactured of any suitable material, for example fiberglass, epoxy-coated steel, plastic or concrete. The size of the treatment chamber 60 and its volume are determined by the size of each contaminated site.

Optionally, an ultraviolet source (not shown) applies ultraviolet radiation to the treated sewage effluent 70 before the treated sewage effluent 70 is distributed into the contaminated soil 200. In areas of high water tables, fresh water resources, or fast percolating soils, in which the treated sewage effluent 70 may contact any form of water at the endpoint of final distribution, the use of an ultraviolet (UV) radiation or other treatment unit may be used to reduce fecal coliforms to a range of about 2-500 CFU/100 ml in the treated sewage effluent 70.

The influent chamber 20, treatment chamber 60, and distribution chamber 90 may be at least partially buried in the ground or housed in a permanent or temporary structure above ground or in a mobile container. In cold climate conditions, components may be insulated. When housed in a mobile container or a structure, a space between the chambers and the container or housing may be completely filled with insulation. A heater may be used to maintain a temperature range of about 15° C. and to about 35° C. the space.

The size of the influent chamber 20, treatment chamber 60 and distribution chamber 90, treatment process used, sewage 30 selection, oxygen supply, and heat source may each be determined and engineered for each specific contaminated site. For example, the design may take into consideration the size, shape, and depth of the,contaminated area, the type and concentration of contaminants, sewage type and availability, treatment quality required to meet environmental standards, regulatory standards, desired remediation rate, climate conditions, and percolation rates of the soil.

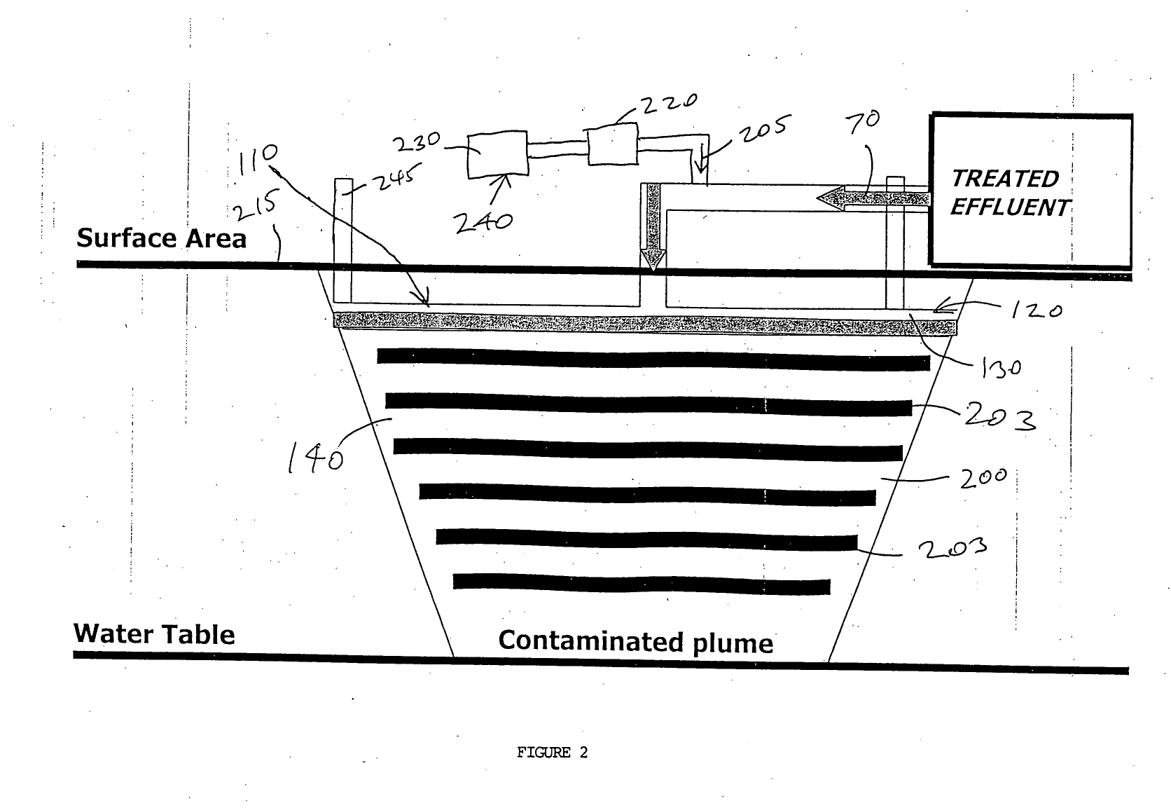

Preferably, a field distribution system 10 is used to apply the treated sewage effluent 70 to a distribution field 140 associated with the contaminated soil 200. The volume of treated sewage effluent 70 that will be delivered into the distribution field 140 will be designed site-specific to the volume of field requirements and the sewage 30 available (see also FIGS. 2 to 4).

The treated sewage effluent 70 is transported to a field distribution system 110 as a means to contact the treated sewage effluent 70 with the contaminated soil 200. The field distribution system 110 is a distribution network having an arrangement or combination of substantially vertical or substantially horizontal passages, or inclined passage, flow permeable conduits, or perforated pipes. The substantially horizontal passages are the most important with access to the source of effluent.

The field distribution system 110 consists of a pipe network 120 having a plurality of perforated pipes 130 placed horizontally or vertically in the distribution field 140. The field distribution system 110 may be placed for surface discharge or for discharge at a depth (e.g. subsurface).

The perforated pipes 130 may be in the form of a grid to substantially extend across the distribution field 140, and may be placed horizontally and/or vertically in the contaminated soil 200. The perforated pipes 130 may be used to distribute the treated sewage effluent 70 evenly throughout the distribution field 140, or focus on any isolated area or “pocket” of contamination, or both, or can be used to deliver the treated sewage effluent 70 at or through a depth suitable to treat a “plume” of contamination. For example, in the case of a plume of contamination formed below the site of a leaking tank, a horizontal field of perforated pipes 130 may be placed near the surface of the contaminated soil 200 and one or more vertical perforated pipes 130 may be extended downward in to the plume.

Referring to FIGS. 1-4, in the preferred embodiment, a field warming system 240 is adapted to supply warm air 205 on or below the surface 215 of the contaminated soil 200. However, the field warming system 240 is not essential to the invention. As mentioned previously, the field warming system 240 may be used to help promote or accelerate remediation, particularly where the contaminated soil 200 temperature drops below about 10° C. for periods of time. The apparatus 10 may also provide heat by the application of the treated sewage effluent 70, which is preferably warm, or by the field warming system 240. For example, the field warming system 240 could be used in cold climatic conditions, especially during the winter months. The field warming system 240 may be a stand alone system adapted to distribute the warm air 205 near the perforated pipes 130, or it may comprise at least a portion of the field distribution system 110, or both. The warm air 205 helps create a thermal barrier layer between the surface 215 and the contaminated soil 200 below where the microorganisms break down the contaminant 203. However, in the preferred embodiment, the warm air 205 is supplied to the contaminated soil 200 utilizing the pipe network 120 of the field distribution system 110. A heater 220 is used to heat air supplied by a blower 230 to the field distribution system 110. Preferably, the warm air 205 is supplied at a temperature of between about 15° C. to about 37° C. In the preferred embodiment, the treated sewage effluent 70 is applied to the contaminated soil 200 in batches or cycles, and the warm air is applied between batches or cycles of the treated sewage effluent 70.

The total volume (“volume capable”) of the pipe network 120, the depth of the pipe network 120, percolation rates of soil, soil classification, size of contamination zone, and concentration of contamination will determine the number of cycles/day being introduced into the pipe network 120. The number of cycles and volume/cycle will determine the pump size (if a pump is to be used). Although cycles with volumes designed to fill the entire pipe network 120 are preferred for an even percolation rate covering the entire distribution field 140, a continuous flow by pump, dousing system or gravity feed may be used. Preferably, the effluent is pumped into the distribution system to fill the distribution system. Then the pump is shut off and the effluent drains by gravity from the distribution system and percolates into the soil.

In cold climate conditions, the warm air 205, may be supplied at a temperature between about 15° C. and about 40° C., but preferably up to about 37° C. The warm air 205 may be distributed continuously with no interruptions when using the field warming system 240 that is separate from the field distribution system 110, or distributed continuously, but interrupted by cycles of treated sewage effluent 70 when using at least a portion of the field distribution system 110.

The layout of the field distribution system 110 or the field warming system 240 may be designed to allow the treated sewage effluent 70 to capture and carry the warm air 205 to greater depths during percolation creating a warm environment in the contaminated soil 200 to initiate, promote, or expedite bioremediation.

The treated sewage effluent 70 may be applied above the contaminant 203 and allowed to percolate down by gravity to or proximate to the contaminant 203 (for example, where the contaminated soil 200 has a high permeability). The treated sewage effluent 70 may be applied below the contaminant 203 to create a barrier zone to protect groundwater from the contaminant 203 or to create a thermal barrier below the contaminant 203 during or prior to the application of the treated sewage effluent 70 to the contaminant 203 in the contaminated soil 200.

Referring to FIG. 2, the treated sewage effluent 70 may be pumped in cycles into the distribution field 140 through the pipe network 120. The cycle is designed so that sufficient quantity of the treated sewage effluent 70 is delivered to fill the pipe network 120, and then the treated sewage effluent 70 is allowed to slowly disperse through the perforated pipes 130 into the contaminated soil 200. Excess air can be allowed to escape from the system through vertical outlets 245. Once the treated sewage effluent 70 is dispersed, the cycle may be repeated as required.

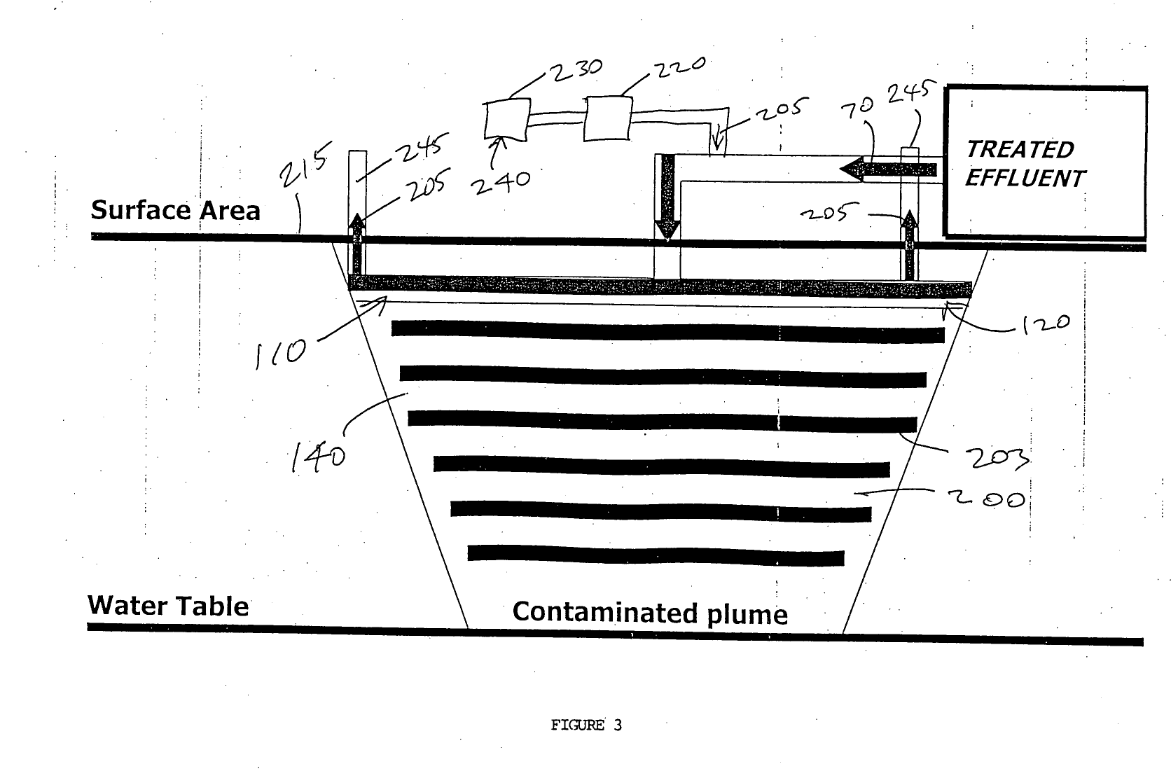

Referring to FIG. 3, the pipe network 120 may be used to supply the warm air 205 to the distribution field 140. When the treated sewage effluent 70 has filled the pipe network 120, an automatic transfer switch (not shown) shuts down the pump (not shown) and turns on the hot air blower 230 and heater 220. The warm air 205 is distributed through the same pipe network 120 until the pump (not shown) is ready to cycle and fill the pipe network 120 again with the treated sewage effluent 70. When the treated sewage effluent 70 is dispersed, the cycle may be repeated as required. Depending on the temperature of the ambient air, the blower can preferably be activated with or without the heater.

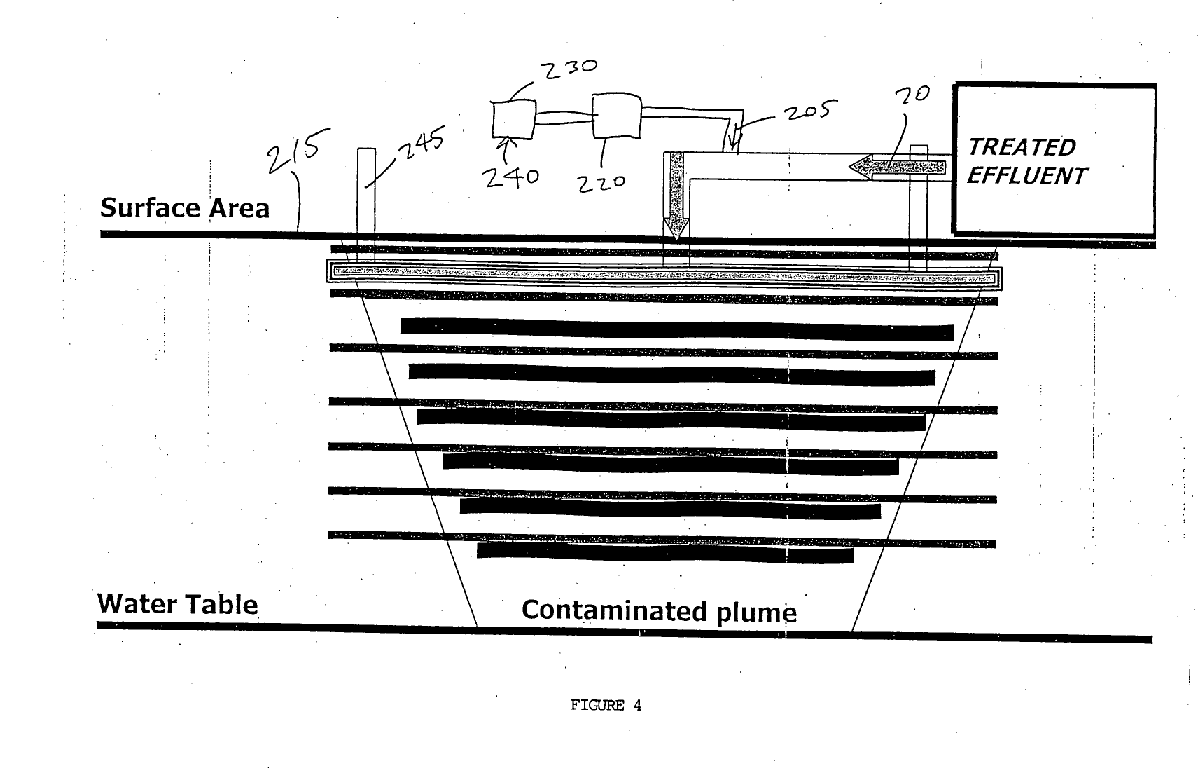

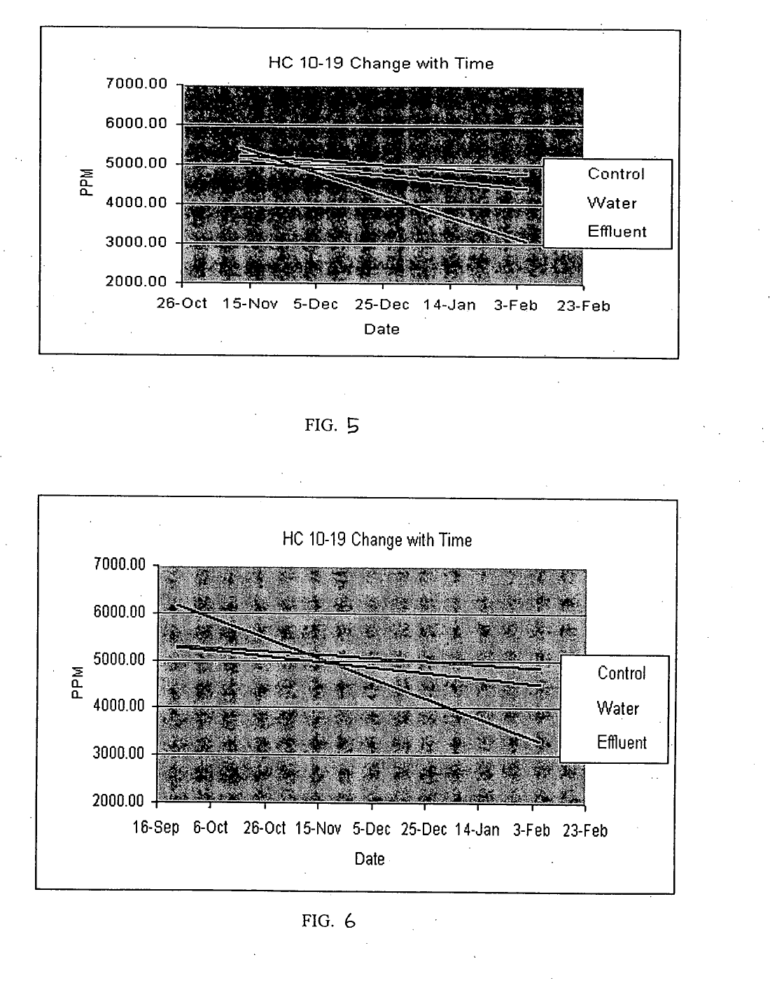

Referring to FIG. 4, the warm air 205 creates a thermal barrier at or near the surface 215. In freezing climates, this would help reduce the risk of frost penetrating below the surface 215 to the pipe network 120. Preferably, the thermal barrier is maintained at a temperature of between about 5° C. and about 35° C. This will reduce or eliminate the risk of frost penetrating below the surface level, and reduce or eliminate the risks of the treated sewage effluent 70 freezing. In addition, this will help provide a warm environment to initiate, promote, or expedite bioremediation. The heated air remains in the pipes until the pump is ready to recycle. When the pump (not shown) cycles, the treated sewage effluent 70 will carry the warm air 205 to greater depths as it percolates or migrates downward.

An experiment was conducted to assess the effectiveness of the process and system in accordance with the present invention, and the experiment details and results are listed below in Example 1.

### EXAMPLE 1

### Simulated In situ, Cold Climate Conditions

During the period from Sep. 23, 2003 to Feb. 6, 2004 (137 days), test results were recorded for a remediation process of the present invention applied in situ to soil contaminated with diesel fuel.

Treated sewage effluent (being Residential Sewage) acquired from a residential lift station was applied in amounts of 6 liters daily to four contaminated containers for 59 days. Water was applied in amounts of 6 liters daily to four equally contaminated containers for 59 days. Two additional equally contaminated containers were left untouched for control purposes. The soil temperature was maintained at 6-10° C. The contaminated soil in the containers was created by mixing 199 litres of diesel fuel with 12 m³ of pit run gravel having a moisture content ranging from 0.7 to 4.6% and dividing the contaminated soil into ten equal batches of 1.2 m³ each and placing one batch in each of ten equally sized containers.

After 59 days of treated sewage effluent application, a 34% decrease in hydrocarbon concentration was measured, and the hydrocarbon concentration decreased another 6% measured 23 days after the final application of treated sewage effluent. After 59 days of water application, a negligible change in hydrocarbon concentration was measured. After 59 days, a negligible change in hydrocarbon concentration was measured in the control containers. Remediation of roughly 9 to 10% was achieved in the containers to which water was added and remediation of roughly 4 to 5% was achieved in the control containers. These results are considered to be negligible due to the freshly premixed soil and diesel batching causing some natural attenuation during the early stages of the process.

The average hydrocarbon concentration in the four containers which received treated sewage effluent decreased from 5,912 ppm on Nov. 15, 2003 (start of treatment) to 3,545 ppm on Feb. 6, 2004 (the last sample date), showing a 40% overall remediation in 82 days. A 30% remediation over the water and control containers was achieved.

The time period to remediate or partially remediate contaminated soil will vary with the type of contaminant, the site conditions, the type of treated effluent and other factors, but the remediation process will be significantly accelerated by the present invention compared to the time period required for natural remediation.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

It will be readily seen by those skilled in the art that various modifications of the present invention may be devised without departing from the essential concept of the invention, and all such modifications are intended to be included in the scope of the claims appended hereto.

1. A process for in situ remediation of contaminated soil, said soil being contaminated with at least one contaminant selected from the group of hydrocarbons, BTEX compounds, polyaromatic hydrocarbons and pentachlorophenol, said process comprising:
(a) choosing a treated sewage effluent, said effluent having a maximum biochemical oxygen demand five day test and total suspended solids in water of substantially 10 to 160 milligrams per litre; and
(b) distributing said effluent into said soil and waiting a period of time to allow said effluent to cause said contaminant to be at least partially remediated.

2. A process as claimed in claim 1 including the step of choosing a treated sewage effluent that has total suspended solids in water that is at least one selected from the group of substantially 140 to 160 per litre, substantially 45 to 140 milligrams per litre, substantially 30 to 45 milligrams per litre, substantially 10 to 30 milligrams per litre and substantially 10 milligrams per litre.

3. A process as claimed in claim 1 including the step of choosing a treated sewage effluent that has a quality of at least one selected from the group of Primary effluent quality, Secondary effluent quality and Tertiary effluent quality.

4. A process as claimed in any one of claims 1, 2 or 3 including the steps of distributing said effluent into said soil in cycles, creating said cycles by interrupting said distribution of said effluent into said soil, waiting a period of time and subsequently adding more effluent to said soil and waiting a further period of time.

5. A process as claimed in any one of claims 1, 2 or 3 including the steps of carrying out the process in cycles and repeating the process in cycles until said contaminant has been at least substantially remediated.

6. A process as claimed in any one of claims 1, 2 or 3 including the step of blowing warm air into said soil after distributing said effluent.

7. A process as claimed in any one of claims 1, 2 or 3 including the steps of carrying out the process in cycles and blowing warm air into said soil between cycles.

8. A process as claimed in any one of claims 1, 2 or 3 including the steps of forming a distribution system within said soil using at least one vertical or inclined flow permeable passage.

9. A process as claimed in any one of claims 1, 2 or 3 including the steps of forming a distribution system in said soil in the form of a grid with substantially horizontal flow permeable passages and connecting said grid to at least one vertical or inclined flow permeable passage.

10. A process as claimed in any one of claims 1, 2 or 3 wherein said soil contains ground water that is contaminated with said contaminant, said process comprising distributing said effluent into said ground water to at least partially remediate said ground water.

11. A process as claimed in any one of claims 1, 2 or 3 including the step of using the process to treat contaminants where at least one contaminant is selected from the group of petroleum hydrocarbons, light extractable petroleum hydrocarbons, heavy extractable petroleum hydrocarbons and volatile petroleum hydrocarbons.

12. The process as claimed in any one of claims 1, 2 or 3 including the step of maintaining said treated sewage effluent at between about 15° C. to about 37° C.

13. The process as claimed in any one of claims 1, 2 or 3 including the step of maintaining said treated sewage effluent at between about 25° C. to about 35° C.

14. The process as claimed in any one of claims 1, 2 or 3 further comprising oxygenating said treated sewage effluent before said effluent is distributed.

15. The process as claimed in claim 3 further comprising treating sewage with a treatment process to form said treated sewage effluent.

16. The process as claimed in claim 15, wherein said treatment process comprises a fixed activated sludge treatment system that produces effluent of tertiary effluent quality.

17. The process as claimed in any one of claims 1, 2 or 3 including the step of choosing the sewage from at least one selected from the group of Residential Sewage, Commercial Wastewater, High Strength Sewage, Blackwater, Blackwater/Greywater, and Agricultural Wastewater.

18. The process as claimed in any one of claims 1, 2, or 3 further comprising applying ultraviolet radiation to the treated sewage effluent before distributing said effluent into said soil.

19. The process as claimed in any one of claims 1, 2 or 3, including the step of maintaining said soil at a temperature of at least about 5° C.

20. The process as claimed in any one of claims 1, 2 or 3 including the step of maintaining said soil at a temperature of at least about 10° C.

21. The process as claimed in any one of claims 1, 2 or 3 including the step of distributing said treated sewage effluent into the soil by irrigation.

22. The process as claimed in any one of claims 1, 2 or 3 including the step of distributing at least a portion of said treated sewage effluent into said soil at grade level.

23. The process as claimed in any one of claims 1, 2 or 3 including the step of distributing at least a portion of said treated sewage effluent into said soil below grade level.

24. The process as claimed in any one of claims 1, 2 or 3 including the step of distributing at least a portion of said treated sewage effluent into the soil above the contaminant.

25. The process as claimed in any one of claims 1, 2 or 3 including the step of distributing at least a portion of said treated sewage effluent into the soil below the contaminant.

26. The process as claimed in any one of claims 1, 2 or 3, including the step of distributing the treated sewage effluent into said soil that is proximate to groundwater contaminated with the contaminant, wherein remediation of the soil promotes remediation of the contaminated groundwater.

27. The process as claimed in any one of claims 1, 2 or 3 including the step of distributing said treated sewage effluent into the soil having an interface with groundwater contaminated with said contaminant, wherein remediation of the soil promotes remediation of the contaminated groundwater proximate to the interface.

28. The process as claimed in any one of claims 1, 2 or 3 including the steps of producing said treated sewage effluent by treating sewage, receiving said sewage in an influent chamber and passing said sewage into a treatment chamber, treating said sewage in said treatment chamber to one quality selected from the group of primary, secondary or tertiary effluent quality.

29. The process as claimed in any one of claims 1, 2 or 3 including the steps of producing said treated sewage effluent by treating sewage, receiving said sewage in an influent chamber and passing said sewage into a treatment chamber, treating said sewage in said treatment chamber to one quality selected from the group of primary, secondary or tertiary effluent quality, treating said sewage to provide a total nitrogen reduction of 70%.

30. The process as claimed in any one of claims 1, 2 or 3 including the steps of producing said treated sewage effluent by treating sewage, receiving said sewage in an influent chamber and passing said sewage into a treatment chamber, treating said sewage in said treatment chamber to one quality selected from the group of primary, secondary or tertiary effluent quality, removing nitrates so that a nitrate level in said treated sewage effluent is less than 5 milligrams per litre.

31. The process as claimed in any one of claims 1, 2 or 3 including the step of testing a concentration of said contaminant after waiting said period of time.

32. A system for remediation of contaminated soil, said soil being contaminated with at least one contaminant selected from the group of hydrocarbons, BTEX compounds, polyaromatic hydrocarbon compounds and pentachlorophenol, said process comprising a treated sewage effluent having a maximum biochemical oxygen demand five day test and total suspended solids of substantially 10 to 160 milligrams per litre of water, means for contacting said contaminant with said effluent to at least partially remediate said contaminant after a period of time.

33. A system for remediation of contaminated soil as claimed in claim 32 wherein said effluent has at least one of total suspended solids in water selected from the group of substantially 140 to 160 milligrams per litre, substantially 45 to 140 milligrams per litre, substantially 30 to 45 milligrams per litre, substantially 10 to 30 milligrams per litre and substantially 10 milligrams per litre.

34. A system for remediation of contaminated soil as claimed in claim 32 wherein said treated sewage effluent has a quality of at least one selected from the group of Primary effluent quality, Secondary effluent quality and Tertiary effluent quality.

35. A system as claimed in any one of claims 32, 33 or 34 wherein said means for contacting said contaminant with said effluent is a distribution network formed of flow permeable passages.

36. A system for remediating contaminated soil as claimed in any one of claims 32, 33, or 34 wherein said means to contact said contaminant with said effluent is a distribution network formed of at least one substantially vertical or inclined passage.

37. A system for remediating contaminated soil as claimed in any one of claims 32, 33, or 34 wherein said means to contact said contaminant with said effluent is a grid system connecting substantially horizontal flow permeable passages with at least one substantially vertical or inclined passage.

38. A system as claimed in claim 32 wherein said means to contact said effluent with said soil is a distribution network formed of flow permeable conduits.

39. A system as claimed in claim 38 wherein said flow permeable conduits are perforated pipes.

40. A system for remediating contaminated soil as claimed in any one of claims 32, 33 or 34 further comprising sewage treatment means for treating sewage to prepare the treated sewage effluent.

41. A system for remediating contaminated soil as claimed in any one of claims 32, 33 or 34 comprising sewage treatment means for treating sewage to obtain said treated sewage effluent, said treatment means comprising a fixed activated sludge treatment system.

42. A system for remediating contaminated soil as claimed in claim 32 wherein there is a distribution network in said soil for said treated sewage effluent, with means to blow air into said distribution network between cycles.

43. A system for remediating contaminated soil as claimed in claim 42 wherein there are means to heat said air before it is blown into said distribution network.

44. A system for remediating contaminated soil as claimed in claim 32 wherein there is a distribution network for said effluent and a separate distribution network for air.
